(19) United States
(12) Patent Application Publication
(10) Pub. No.: US 2025/0362698 A1
(43) Pub. Date: Nov. 27, 2025

(54) VOLTAGE REGULATOR AND OPERATING METHOD THEREOF

(71) Applicant: Samsung Electronics Co., Ltd., Suwon-si (KR)

(72) Inventors: Huidong GWON, Suwon-si (KR); Byongdeok CHOI, Seoul-si (KR); Junhyeok YANG, Suwon-si (KR); Sungmin YOO, Suwon-si (KR); Junhwan JANG, Seoul-si (KR); Hyungmin SONG, Seoul-si (KR)

(73) Assignees: Samsung Electronics Co., Ltd., Suwon-si (KR); IUCF-HYU (Industry-University Cooperation Foundation Hanyang University), Seoul (KR)

(21) Appl. No.: 19/085,074

(22) Filed: Mar. 20, 2025

(30) Foreign Application Priority Data
May 21, 2024 (KR) 10-2024-0065858
Aug. 7, 2024 (KR) 10-2024-0105744

(51) Int. Cl. G05F 1/575; G05F 1/569

(52) U.S. Cl. CPC G05F 1/575; G05F 1/569

(57) ABSTRACT

A voltage regulator includes an error amplifier, a first transistor having a gate terminal electrically connected to a first node, a second transistor having a gate terminal electrically connected to a second node, a frequency compensation circuit electrically connected to the first node and the second node, a bypass switch having a first terminal electrically connected to the first node and a second terminal electrically connected to the second node, and a transient detector configured to control the bypass switch based on a change in an output voltage.

### CROSS-REFERENCE TO RELATED APPLICATIONS

This U.S. non-provisional application claims priority under 35 U.S.C. § 119 to Korean Patent Application Nos. 10-2024-0065858, filed on May 21, 2024, and 10-2024-0105744, filed on Aug. 7, 2024, in the Korean Intellectual Property Office, the disclosures of which are incorporated by reference herein in their entirety.

### BACKGROUND

Example embodiments of the inventive concepts relate to a voltage regulator, and to a method of improving the load transient response performance of a voltage regulator through a bypass switch.

In semiconductor devices such as a system-on-chip (SoC), it is beneficial to use low dropout (LDO) voltage regulators for voltage stabilization and power management. It may be advantageous to use LDO voltage regulators having higher bandwidth with semiconductor devices having improved performances. When a voltage regulator has a higher bandwidth, the voltage regulator may respond to a change in load relatively quickly and stabilize the change relatively quickly. However, an improvement in the bandwidth may lower load transient performance when a sudden change occurs in the load of a regulator. This may cause lower overall performance and may case malfunction of electronic devices including an LDO voltage regulator.

### SUMMARY

Some example embodiments of the inventive concepts provide a voltage regulator having improved load transient performance, thereby providing a relatively higher bandwidth and lowering or minimizing performance degradation caused by load transient response.

Example embodiments of the inventive concepts are not limited to those mentioned above, and it should be understood that the example embodiments may be embodied in many other forms, without departing from the spirit or scope of the present disclosure, by those skilled in the art from the description below.

According to some example embodiments of the inventive concepts, a voltage regulator may include an error amplifier configured to receive a reference voltage through a first input terminal and electrically connected to an output node of the voltage regulator through a second input terminal, a first transistor having a gate terminal electrically connected to a first node, a second transistor having a gate terminal electrically connected to a second node, a frequency compensation circuit electrically connected to the first node and the second node, a bypass switch connected in parallel with the frequency compensation circuit, and a transient detector configured to control the bypass switch based on a change in an output voltage. The voltage regulator is configured to receive an input voltage through a first terminal of each of the first transistor and the second transistor and output the output voltage through the output node that is electrically connected to a second terminal of each of the first transistor and the second transistor.

According to some example embodiments of the inventive concepts, an operating method of a voltage regulator may include detecting a change in an output voltage of the voltage regulator, comparing a difference between a reference voltage and the output voltage with a reference voltage difference, switching a bypass switch to a closed state in response to the difference between the reference voltage and the output voltage being greater than the reference voltage difference, after switching the bypass switch to the closed state, comparing the difference between the reference voltage and the output voltage with the reference voltage difference, and switching the bypass switch to an open state in response to the difference between the reference voltage and the output voltage being less than the reference voltage difference.

According some example embodiments of the inventive concepts, a voltage regulator may include an error amplifier configured to receive a reference voltage through a first input terminal and electrically connected to an output node of the voltage regulator through a second input terminal, a first transistor having a gate terminal electrically connected to a first node, a second transistor having a gate terminal electrically connected to a second node, a third transistor having a gate terminal electrically connected to a third node, a first frequency compensation circuit electrically connected to the first node and to the second node, a second frequency compensation circuit electrically connected to the second node and to the third node, a bypass switch connected in parallel with the first frequency compensation circuit, and a transient detector configured to control the bypass switch based on a change in an output voltage. The voltage regulator is configured to receive an input voltage through a first terminal of each of the first transistor and the second transistor and output the output voltage through the output node electrically connected to a second terminal of each of the first transistor and the second transistor.

### BRIEF DESCRIPTION OF THE DRAWINGS

Example embodiments will be more clearly understood from the following detailed description taken in conjunction with the accompanying drawings in which:

FIG. 1 is a block diagram of an integrated circuit according to some example embodiments.

FIG. 2 is a circuit diagram of an integrated circuit according to some example embodiments.

FIGS. 3A and 3B are graphs illustrating the operation of a voltage regulator, according to some example embodiments.

FIG. 4 is a circuit diagram of a first amplifier according to some example embodiments.

FIG. 5 is a circuit diagram of a second amplifier according to some example embodiments.

FIG. 6 is a circuit diagram of a transient detector according to some example embodiments.

FIG. 7 is a flowchart of an operating method of a voltage regulator, according to some example embodiments.

FIG. 8 is a block diagram of an integrated circuit according to some example embodiments.

FIG. 9 is a block diagram of an integrated circuit according to some example embodiments.

FIG. 10 is a block diagram of an integrated circuit according to some example embodiments.

FIG. 11 is a block diagram of an integrated circuit according to some example embodiments.

FIG. 12 is a block diagram of an integrated circuit according to some example embodiments.

FIG. 13 is a block diagram of a system-on-chip according to some example embodiments.

### DETAILED DESCRIPTION

Hereinafter, some example embodiments are described with reference to the accompanying drawings. Like reference numerals or characters in the drawings denote like elements, and a repeat description thereof is omitted for the sake of brevity.

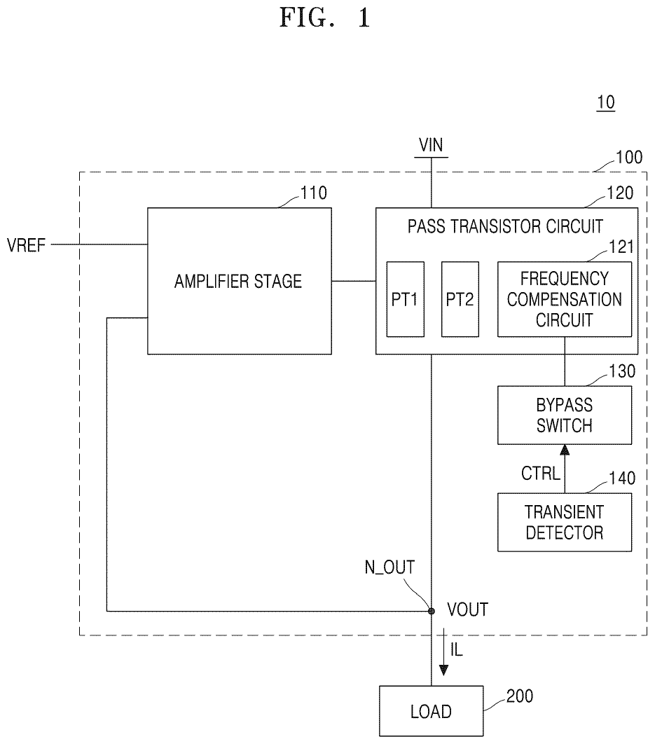

FIG. 1 is a block diagram of an integrated circuit 10 according to some example embodiments.

Referring to FIG. 1, the integrated circuit 10 may include a voltage regulator 100 and a load 200.

The integrated circuit 10 may include a processor, such as a central processing unit (CPU), an application processor (AP), or a system-on-chip (SoC), and may process data. The load 200 may be or include a circuit or functional block that causes power consumption in the integrated circuit 10.

The voltage regulator 100 may be or include a low dropout (LDO) regulator. The voltage regulator 100 may receive a reference voltage VREF and an input voltage VIN, both provided to the voltage regulator 100 from source(s) external to the voltage regulator 100. The voltage regulator 100 may generate an output voltage VOUT based on the reference voltage VREF and the input voltage VIN and provide the output voltage VOUT to the load 200.

The voltage regulator 100 may include an amplifier stage 110, a pass transistor circuit 120, a frequency compensation circuit 121, a bypass switch 130, and/or a transient detector 140.

The amplifier stage 110 may include at least one amplifier. The reference voltage VREF (e.g., a predetermined or desired voltage) provided from the outside may be applied to a first input terminal of the amplifier stage 110. A second input terminal of the amplifier stage 110 may be electrically connected to an output node N_OUT of the voltage regulator 100. The amplifier stage 110 may be electrically connected to the pass transistor circuit 120.

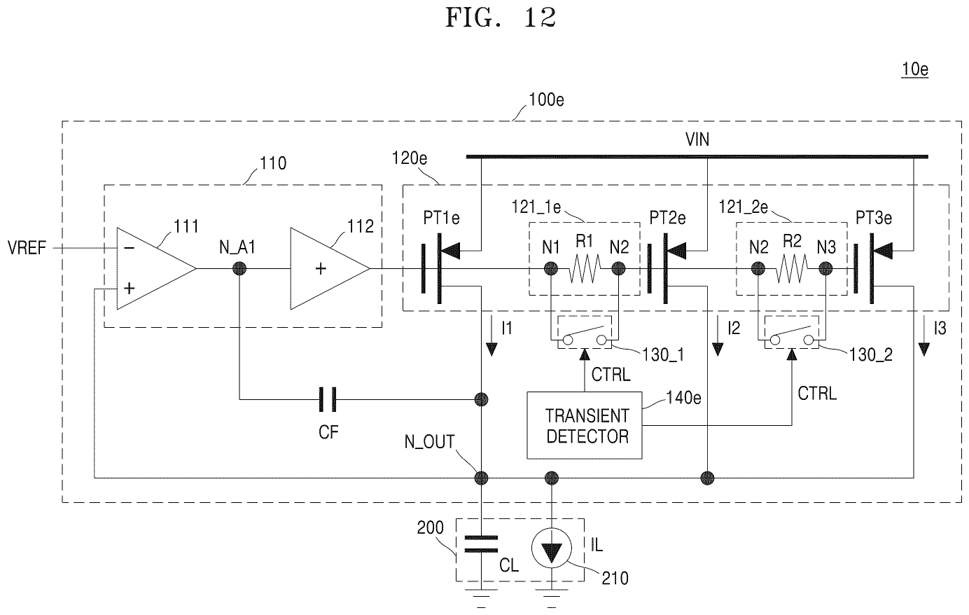

The pass transistor circuit 120 may include a first pass transistor PT1, a second pass transistor PT2, and the frequency compensation circuit 121. Although it is illustrated in FIG. 1 that the pass transistor circuit 120 includes two pass transistors, this is just an example. In some example embodiments, the pass transistor circuit 120 may include a single pass transistor or more than two pass transistors. The input voltage VIN may be provided to the pass transistor circuit 120. In some example embodiments, the pass transistor circuit 120 may include three pass transistors, as described with reference to FIG. 12 below.

The frequency compensation circuit 121 may be electrically connected between the first pass transistor PT1 and the second pass transistor PT2 of the pass transistor circuit 120. The frequency compensation circuit 121 may shift the gate pole of the pass transistor circuit 120 to a high frequency region such that the bandwidth of the voltage regulator 100 may increase, improve, or be maximized.

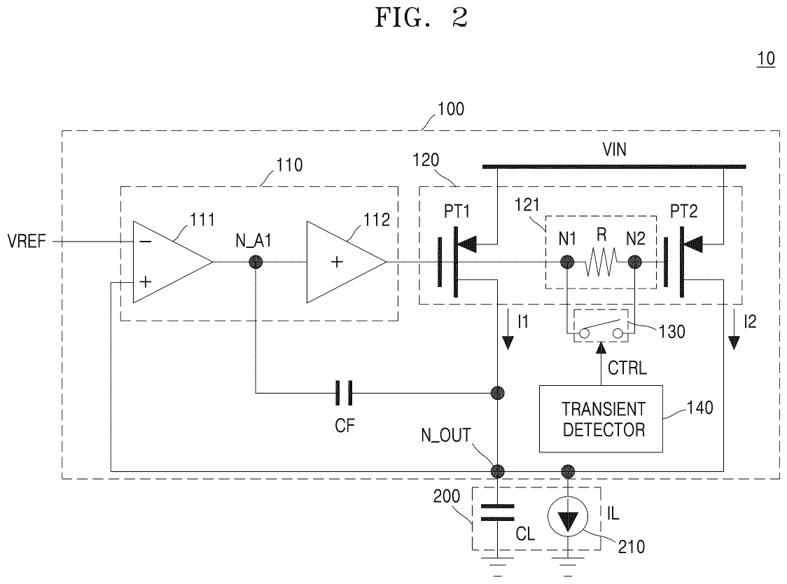

In some example embodiments, the frequency compensation circuit 121 may include a resistor, as discussed with reference to FIG. 2 below.

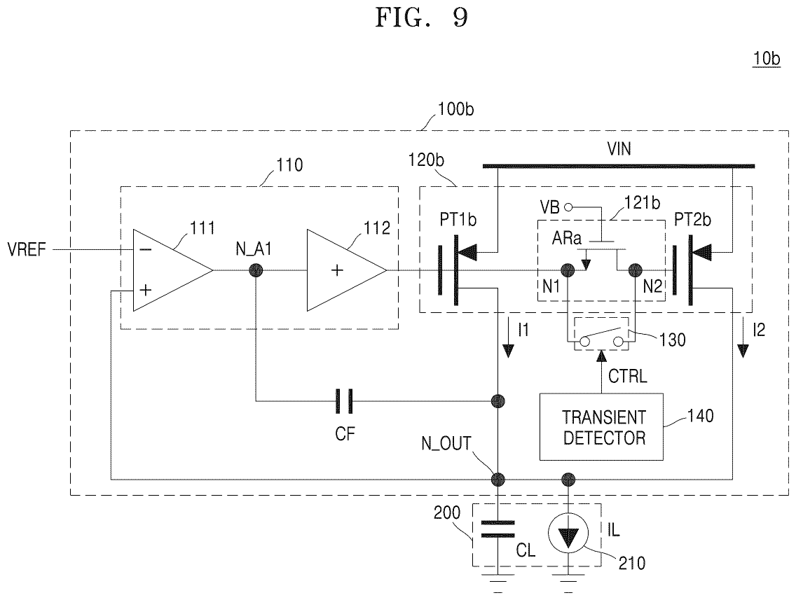

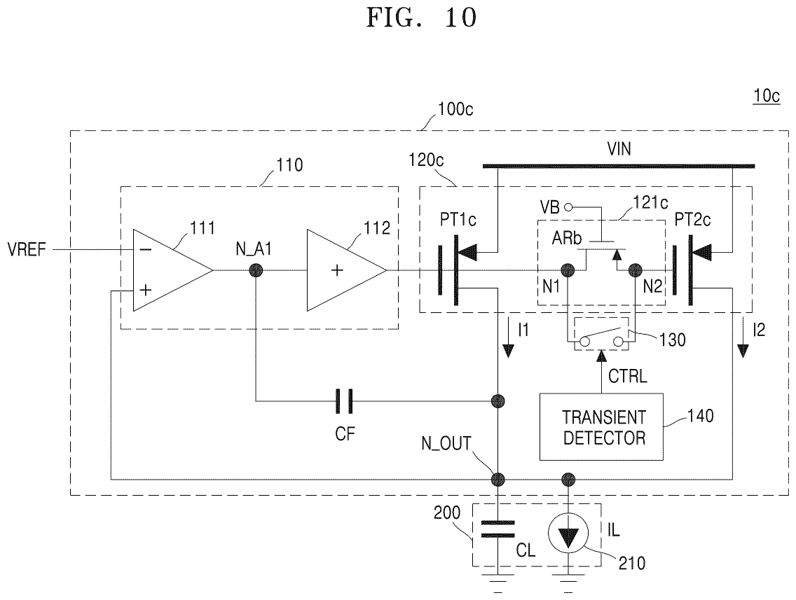

In some example embodiments, the frequency compensation circuit 121 may include an N-channel metal-oxide semiconductor (NMOS) transistor or a P-channel MOS (PMOS) transistor, as discussed with reference to FIGS. 9 and 10 below.

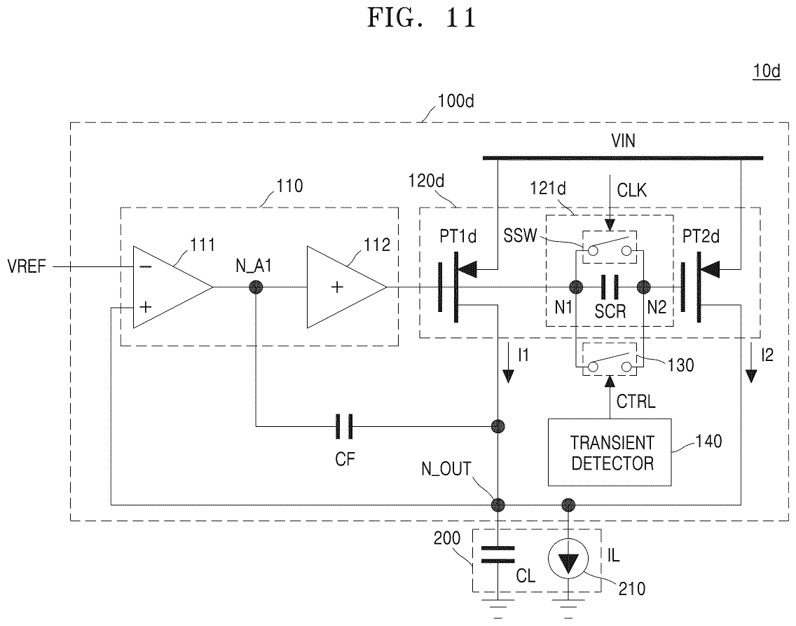

In some example embodiments, the frequency compensation circuit 121 may include a capacitor and a switch operating based on a clock signal, as discussed with reference to FIG. 11 below.

The bypass switch 130 may be connected in parallel with the frequency compensation circuit 121 and may short-circuit the frequency compensation circuit 121 by operating under control by the transient detector 140.

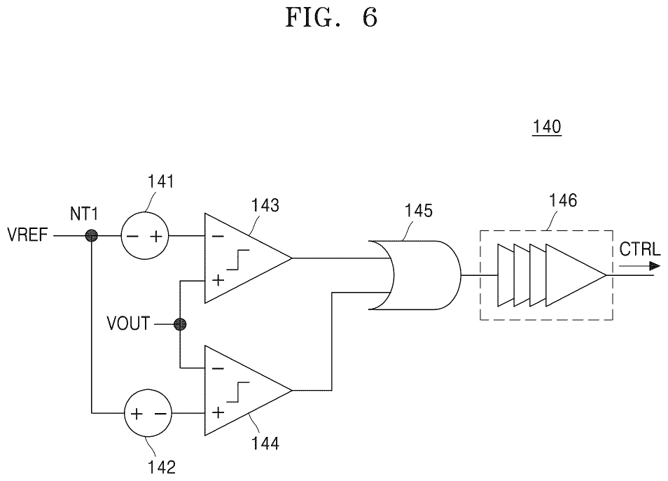

The transient detector 140 may detect a transient in the output voltage VOUT due to the load 200 and generate a control signal CTRL for controlling the bypass switch 130. The transient detector 140 is described with reference to FIGS. 2 and 6 below.

According to some example embodiments, when a load transient occurs in the voltage regulator 100 due to the load 200 (for instance, because of a change in a load current IL in a relatively short time duration (e.g., a sudden change in the load current IL)), the output voltage VOUT of the voltage regulator 100 may be stabilized in a relatively shorter time by detecting the load transient through the transient detector 140 and operating the bypass switch 130.

FIG. 2 is a circuit diagram of the integrated circuit 10 according to some example embodiments. FIG. 2 may be best understood with reference to FIG. 1, where like numerals indicate like elements not described again in detail.

Referring to FIG. 2, the integrated circuit 10 may include the voltage regulator 100 and the load 200.

The voltage regulator 100 may include the amplifier stage 110, the bypass switch 130, the transient detector 140, and/or a feedback capacitor CF. The input voltage VIN and the reference voltage VREF may be provided to the voltage regulator 100. The input voltage VIN and the reference voltage VREF may be generated from source(s) external to the voltage regulator 100.

The amplifier stage 110 may include a first amplifier 111 and a second amplifier 112. The reference voltage VREF may be applied to a first input terminal of the first amplifier 111. A second input terminal of the first amplifier 111 may be electrically connected to the output node N_OUT of the voltage regulator 100. An output terminal of the first amplifier 111 may be electrically connected to a node N_A1. For sake of discussion herein, the first amplifier 111 may be referred to as an error amplifier.

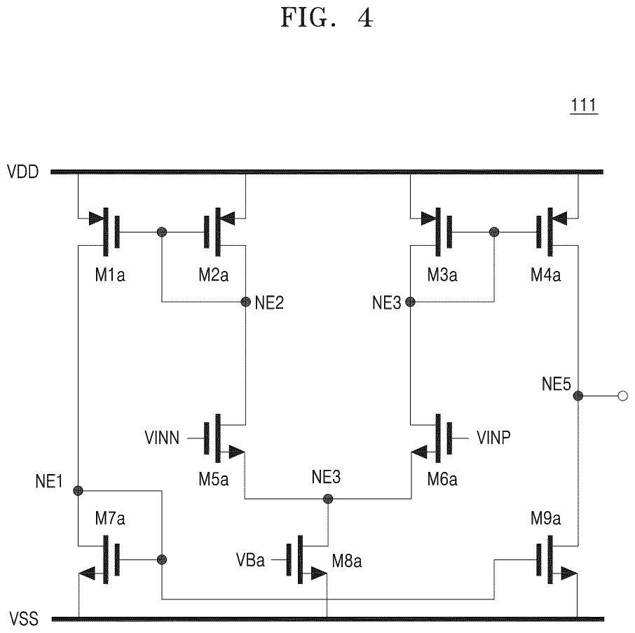

In some example embodiments, the first input terminal of the first amplifier 111 may refer to a non-inverting input terminal, and the second input terminal of the first amplifier 111 may refer to an inverting input terminal. The circuit diagram of the first amplifier 111 is discussed with reference to FIG. 4 below.

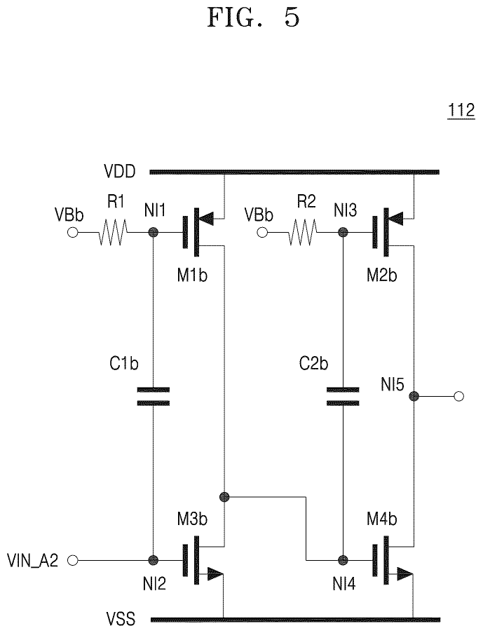

An input terminal of the second amplifier 112 may be electrically connected to the node N_A1. An output terminal of the second amplifier 112 may be electrically connected to a first node N1. The circuit diagram of the second amplifier 112 is discussed with reference to FIG. 5 below.

A first terminal of the feedback capacitor CF may be electrically connected to the node N_A1, and a second terminal of the feedback capacitor CF may be electrically connected to the output node N_OUT.

The pass transistor circuit 120 may include the first pass transistor PT1, the second pass transistor PT2, and the frequency compensation circuit 121.

In some example embodiments, each of the first pass transistor PT1 and the second pass transistor PT2 may be a PMOS transistor, as shown in FIG. 2.

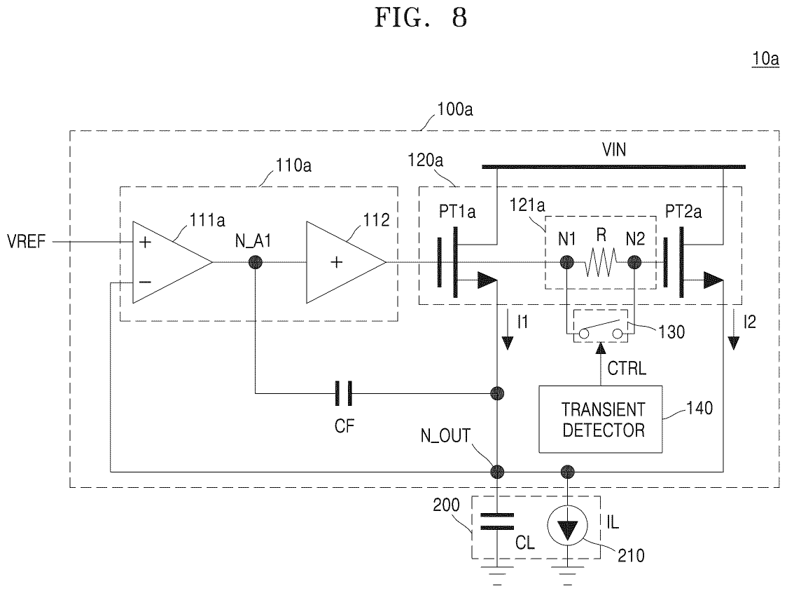

In some example embodiments, each of the first pass transistor PT1 and the second pass transistor PT2 may be an NMOS transistor, as shown in FIG. 8.

The gate of the first pass transistor PT1 may be electrically connected to the first node N1. The input voltage VIN may be applied to a first terminal of the first pass transistor PT1. A second terminal of the first pass transistor PT1 may be electrically connected to the output node N_OUT. A first current I1 may be provided from the second terminal of the first pass transistor PT1 to the output node N_OUT. In some example embodiments, the first terminal of the first pass transistor PT1 may be referred to as a source and the second terminal of the first pass transistor PT1 may be referred to as a drain.

The gate of the second pass transistor PT2 may be electrically connected to a second node N2. The input voltage VIN may be applied to a first terminal of the second pass transistor PT2. A second terminal of the second pass transistor PT2 may be electrically connected to the output node N_OUT. A second current 12 may be provided from the second terminal of the second pass transistor PT2 to the output node N_OUT. In some example embodiments, the first terminal of the second pass transistor PT2 may be referred to as a source and the second terminal of the second pass transistor PT2 may be referred to as a drain.

In some example embodiments, the size of the second pass transistor PT2 may be larger than the size of the first pass transistor PT1. In some example embodiments, the size comparison of pass transistors may be based on the number of unit transistors constituting each of the pass transistors. For example, when a size ratio of the first pass transistor PT1 and the second pass transistor PT2 is 1:9, the first pass transistor PT1 may correspond to one unit transistor and the second pass transistor PT2 may correspond to nine unit transistors.

In some example embodiments, the frequency compensation circuit 121 may include a resistor R. A first terminal of the resistor R may be electrically connected to the first node N1. A second terminal of the resistor R may be electrically connected to the second node N2.

A first terminal of the bypass switch 130 may be electrically connected to the first node N1. A second terminal of the bypass switch 130 may be electrically connected to the second node N2. In other words, the bypass switch 130 may be connected in parallel across the frequency compensation circuit 121. In some example embodiments, the bypass switch 130 may be simply referred to as a switch. In some example embodiments, the bypass switch 130 may be implemented using transistors, logic gates, or other types of circuits that may be switched between a first state in which a conductive path (e.g., current path) is formed thru the circuit and a second state in which a conductive path is not formed thru the circuit.

In some example embodiments, when the bypass switch 130 is in a closed state, current may not flow through the resistor R. When a transient may occur in the voltage regulator 100, the bypass switch 130 may be switched to the closed state. As the bypass switch 130 is switched to the closed state, the output voltage VOUT may be more quickly stabilized (e.g., in a relatively shorter time duration) when a transient occurs in the output of the voltage regulator 100 compared to when the bypass switch 130 is in an open state.

In some example embodiments, when the bypass switch 130 is in the open state, the bandwidth of the voltage regulator 100 may be higher than when the bypass switch 130 is in the closed state. When a transient does not occur in the output of the voltage regulator 100 (for example, when the output of the output voltage VOUT is maintained at a relatively constant level in a normal state), the bypass switch 130 may be switched to the open state. As the bypass switch 130 is switched to the open state, the bandwidth of the voltage regulator 100 may be increased.

When a transient occurs in the output voltage VOUT, for example, in the voltage of the output node N_OUT of the voltage regulator 100, the transient detector 140 may detect the transient and control the bypass switch 130. When the difference between the reference voltage VREF and the output voltage VOUT is greater than a reference voltage difference, the transient detector 140 may control the bypass switch 130 by generating the control signal CTRL that switches the bypass switch 130 to the closed state. When the difference between the reference voltage VREF and the output voltage VOUT is less than or equal to the reference voltage difference, the transient detector 140 may control the bypass switch 130 by generating the control signal CTRL that switches the bypass switch 130 to the open state.

In some example embodiments, the transient detector 140 may compare the absolute value of the difference between the reference voltage VREF and the output voltage VOUT with the reference voltage difference and may determine whether to open or close the bypass switch 130 based on a result of the comparison.

The value of the reference voltage difference may depend on the reference voltage VREF and the output voltage VOUT. For example, when the absolute value of the difference between the reference voltage VREF and the output voltage VOUT is greater than 200 mV, it may indicate that a transient may have occurred in the output of the voltage regulator 100. The transient detector 140 may generate the control signal CTRL that may switch the bypass switch 130 to the closed state. Similarly, when the absolute value of the difference between the reference voltage VREF and the output voltage VOUT is less than or equal to 200 mV, it may indicate that a transient may not have occurred in the output of the voltage regulator 100 or has diminished or lessened. The transient detector 140 may generate the control signal CTRL that may switch the bypass switch 130 to the open state. However, the numerical value of the reference voltage difference is just an example and not intended to limit the example embodiments in any way.

The load 200 may include (among other components) a load capacitor CL and a load current source 210. The load capacitor CL and the load current source 210 may electrically connected to the output node N_OUT.

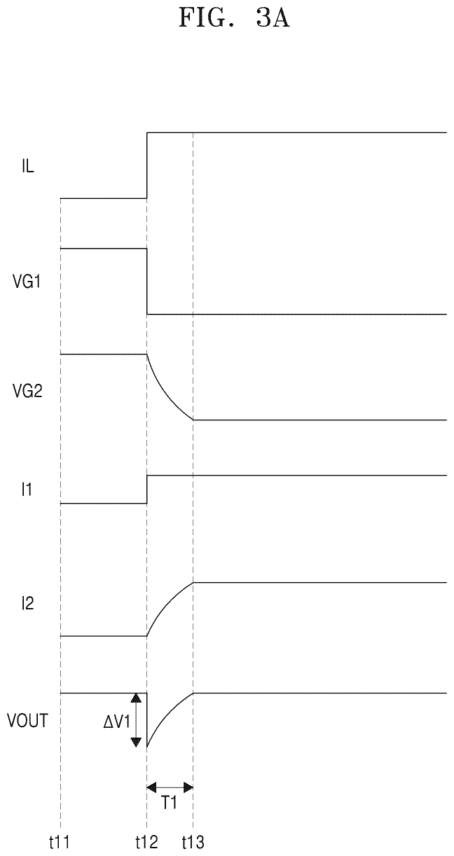

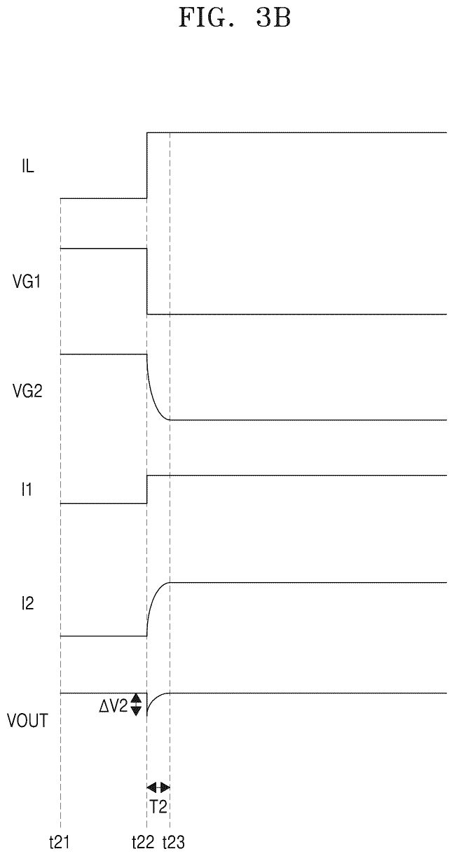

FIGS. 3A and 3B are graphs illustrating the operation of the voltage regulator 100, according to some example embodiments. FIG. 3A is a graph illustrating signal variation when the bypass switch 130 is not operated when a transient may occur in the output of the voltage regulator 100. FIG. 3B is a graph illustrating signal variation when the bypass switch 130 is operated when a transient may occur in the output of the voltage regulator 100. FIGS. 3A and 3B may be best understood with reference to FIGS. 1 and 2.

Referring to FIG. 3A, the load current IL, a first voltage VG1, a second voltage VG2, the first current I1, the second current 12, and the output voltage VOUT may all be maintained at a constant value from a first time point t11 to a second time point t12. In FIGS. 3A and 3B, a first voltage VG1 may refer to the voltage of the first node N1, and the second voltage VG2 may refer to the voltage of the second node N2.

At the second time point t12, the load current IL may instantaneously (e.g., in a relatively shorter time duration) change due to an external cause or a change in the load 200. Due to the instantaneous change of the load current IL, the output voltage VOUT may also instantaneously change at the second time point t12. For example, the voltage level of the output voltage VOUT may decrease by a first voltage difference ΔV1.

As time passes from the second time point t12 to a third time point t13, the voltage level of the output voltage VOUT may return to the voltage level before the second time point t12.

A time period from the second time point t12 to the third time point t13 may be referred to as a first time period T1.

Referring to FIG. 3B, the load current IL, the first voltage VG1, the second voltage VG2, the first current 11, the second current 12, and the output voltage VOUT may all be maintained at a constant value from a first time point t21 to a second time point t22.

At the second time point t22, the load current IL may instantaneously (e.g., in a relatively shorter time duration) change due to an external cause or a change in the load 200. In other words, a transient may occur at the second time point t22. Due to the instantaneous change of the load current IL, the output voltage VOUT may also instantaneously change at the second time point t22.

At this time, the transient detector 140 may detect a transient and switch the bypass switch 130 to the closed state. As the bypass switch 130 is switched to the closed state, the change of the output voltage VOUT may be relatively less than that in the case of FIG. 3A. For example, the voltage level of the output voltage VOUT may decrease by a second voltage difference ΔV2. The second voltage difference ΔV2 may be less than the first voltage difference ΔV1.

As time passes from the second time point t22 to a third time point t23, the voltage level of the output voltage VOUT may return to the voltage level before the second time point t22.

A time period from the second time point t22 to the third time point t23 may be referred to as a second time period T2. The second time period T2 may be relatively shorter than the first time period T1.

According to some example embodiments, by controlling the bypass switch 130 when a transient occurs in the output of the voltage regulator 100, the voltage regulator 100 may reduce the change of the output voltage VOUT and the time taken for the output voltage VOUT to be stabilized to the original voltage level.

FIG. 4 is a circuit diagram of the first amplifier 111 according to some example embodiments. FIG. 4 may be best understood with reference to FIGS. 1 and 2.

Referring to FIG. 4, the first amplifier 111 may include first to ninth transistors M1a to M9a.

Each of the first to fourth transistors M1a to M4a may be a PMOS transistor. Each of the fifth to ninth transistors M5a to M9a may be an NMOS transistor.

The VDD voltage may be applied to the source of each of the first to fourth transistors M1a to M4a. The drain of the first transistor M1a may be electrically connected to a first node NE1. The gate of each of the first transistor M1a and the second transistor M2a may be electrically connected to a second node NE2. The drain of the second transistor M2a may be electrically connected to the second node NE2. The drain of the third transistor M3a may be electrically connected to a third node NE3. The gate of each of the third transistor M3a and the fourth transistor M4a may be electrically connected to the third node NE3. The drain of the fourth transistor M4a may be electrically connected to a fifth node NE5. The fifth node NE5 may be electrically connected to the output terminal of the first amplifier 111. In other words, the voltage of the fifth node NE5 may correspond to the output voltage of the first amplifier 111.

The drain of the fifth transistor M5a may be electrically connected to the second node NE2. A first input voltage VINN may be applied to the gate of the fifth transistor M5a. The source of the fifth transistor M5a may be electrically connected to the third node NE3. The drain of the sixth transistor M6a may be electrically connected to the third node NE3. A second input voltage VINP may be applied to the gate of the sixth transistor M6a. The source of the sixth transistor M6a may be electrically connected to the third node NE3.

The VSS voltage may be applied to the source of each of the seventh to ninth transistors M7a to M9a. The drain and gate of the seventh transistor M7a may be electrically connected to the first node NE1. The drain of the eighth transistor M8a may be electrically connected to the third node NE3. A bias voltage VBa may be applied to the gate of the eighth transistor M8a. The gate of the ninth transistor M9a may be electrically connected to the first node NE1. The drain of the ninth transistor M9a may be electrically connected to the fifth node NE5.

FIG. 5 is a circuit diagram of the second amplifier 112 according to some example embodiments. FIG. 5 may be best understood with reference to FIGS. 1 and 2.

Referring to FIG. 5, the second amplifier 112 may include a first resistor R1, a second resistor R2, a first capacitor C1b, a second capacitor C2b, and first to fourth transistors M1b to M4b. Each of the first transistor M1b and the second transistor M2b may be a PMOS transistor, and each of the third transistor M3b and the fourth transistor M4b may be an NMOS transistor.

The VDD voltage may be applied to the source of each of the first transistor M1b and the second transistor M2b.

The gate of the first transistor M1b may be electrically connected to a first node NI1. The drain of the first transistor M1b may be electrically connected to a fourth node NI4. The gate of the second transistor M2b may be electrically connected to a third node NI3. The drain of the second transistor M2b may be electrically connected to a fifth node NI5. The drain of the third transistor M3b may be electrically connected to the fourth node NI4.

A bias voltage VBb may be applied to one end of the first resistor R1. A second terminal of the first resistor R1 may be electrically connected to the first node NI1.

One end of the first capacitor C1b may be electrically connected to the first node NI1, and a second terminal of the first capacitor C1b may be electrically connected to a second node NI2.

An input voltage VIN_A2 may be applied to the input terminal of the second amplifier 112. The input terminal of the second amplifier 112 may be electrically connected to the second node NI2.

The VSS voltage may be applied to the source of each of the third transistor M3b and the fourth transistor M4b.

The gate of the third transistor M3b may be electrically connected to the second node NI2. The drain of the third transistor M3b may be electrically connected to the fourth node NI4.

The gate of the fourth transistor M4b may be electrically connected to the fourth node NI4. The drain of the fourth transistor M4b may be electrically connected to the fifth node NI5.

The bias voltage VBb may be applied to a first terminal of the second resistor R2. A second terminal of the second resistor R2 may be electrically connected to the third node NI3.

A first terminal of the second capacitor C2b may be electrically connected to the third node NI3, and a second terminal of the second capacitor C2b may be electrically connected to the fourth node NI4.

The fifth node NI5 may be electrically connected to the output terminal of the second amplifier 112. In other words, the voltage of the fifth node NI5 may correspond to the output voltage of the second amplifier 112.

FIG. 6 is a circuit diagram of the transient detector 140 according to some example embodiments. FIG. 6 may be described with reference to FIGS. 1 and 2.

Referring to FIG. 6, the transient detector 140 may include a first voltage source 141, a second voltage source 142, a first comparator 143, a second comparator 144, an OR gate 145, and a buffer circuit 146.

The reference voltage VREF may be applied to a first node NT1. Each of the first voltage source 141 and the second voltage source 142 may be configured such that a voltage difference between two terminals of each of the first and second voltage sources 141 and 142 is the same as the reference voltage difference. For example, the first voltage source 141 may increase the reference voltage VREF by the reference voltage difference and provide an increased voltage (corresponding to the first comparison reference voltage) to an inverting input terminal of the first comparator 143. The second voltage source 142 may decrease the reference voltage VREF by the reference voltage difference and provide a decreased voltage (corresponding to the second comparison reference voltage) to a non-inverting input terminal of the second comparator 144.

A first terminal of the first voltage source 141 may be electrically connected to the first node NT1. A second terminal of the first voltage source 141 may be electrically connected to the inverting input terminal of the first comparator 143.

A first terminal of the second voltage source 142 may be electrically connected to the first node NT1. A second terminal of the second voltage source 142 may be electrically connected to the non-inverting input terminal of the second comparator 144.

The output voltage VOUT generated by the voltage regulator 100 may be applied to the non-inverting input terminal of the first comparator 143 and the inverting input terminal of the second comparator 144.

The output terminal of the first comparator 143 and the output terminal of the second comparator 144 each may be electrically connected to the OR gate 145. Here, a voltage applied to the inverting input terminal of the first comparator 143 may be referred to as a first comparison reference voltage. A voltage applied to the non-inverting input terminal of the second comparator 144 may be referred to as a second comparison reference voltage.

In some example embodiments, the first comparator 143 may provide the OR gate 145 with a first comparison result signal indicating a result of comparing the first comparison reference voltage with the output voltage VOUT. The second comparator 144 may provide the OR gate 145 with a second comparison result signal indicating a result of comparing the second comparison reference voltage with the output voltage VOUT.

The output of the OR gate 145 may correspond to the control signal CTRL. The output terminal of the OR gate 145 may be electrically connected to the buffer circuit 146.

In some example embodiments, the OR gate 145 may perform an OR operation based on the first comparison result signal received from the first comparator 143 and the second comparison result signal received from the second comparator 144 and may generate and provide the control signal CTRL, which corresponds to a result value of the OR operation, to the buffer circuit 146.

The buffer circuit 146 may output the control signal CTRL received from the OR gate 145. In some example embodiments, the buffer circuit 146 may include a plurality of inverters.

The transient detector 140 may determine whether a transient has occurred, based on Equation 1.

|VOUT−VREF|>ΔV. [Equation 1]

In Equation 1, ΔV may refer to the reference voltage difference, VOUT may refer to the output voltage VOUT of the voltage regulator 100, and VREF may refer to the reference voltage VREF provided from the outside.

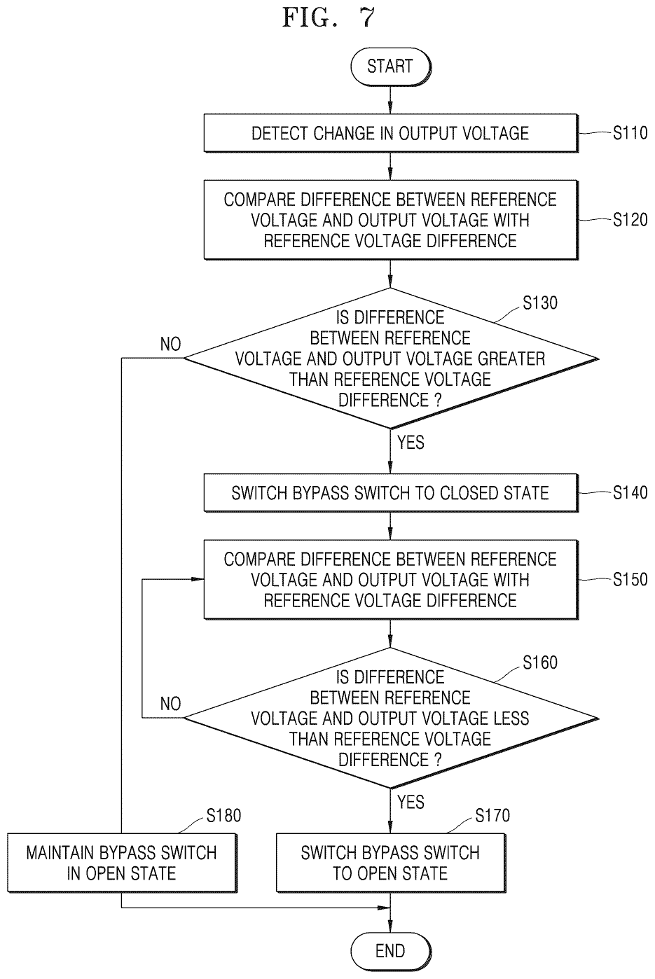

FIG. 7 is a flowchart of an operating method of the voltage regulator 100, according to some example embodiments. FIG. 7 may be described with reference to FIGS. 1 to 6, and may be best understood with reference thereto. It is understood that additional operations can be provided before, during, and after the operations in FIG. 7, and some of the operations described below can be replaced or eliminated, for additional embodiments of the operating method. The order of the operations may be interchangeable, or two or more operations can be performed simultaneously.

Referring to FIG. 7, the voltage regulator 100 may detect a change in the output voltage VOUT in operation S110.

The voltage regulator 100 may compare the difference between the reference voltage VREF and the output voltage VOUT with the reference voltage difference ΔV (Equation 1) in operation S120.

In some example embodiments, the voltage regulator 100 may compare the difference between the reference voltage VREF and the output voltage VOUT with the reference voltage difference according to Equation 1 above.

When the difference between the reference voltage VREF and the output voltage VOUT is greater than the reference voltage difference in operation S130, a load transient may be determined to have occurred in the voltage regulator 100. When the difference between the reference voltage VREF and the output voltage VOUT is greater than the reference voltage difference, the voltage regulator 100 may determine to switch the bypass switch 130 to the closed state.

When the difference between the reference voltage VREF and the output voltage VOUT is less than the reference voltage difference, a load transient may be determined to not have occurred in the voltage regulator 100. When the difference between the reference voltage VREF and the output voltage VOUT is less than the reference voltage difference, the voltage regulator 100 may determine to maintain the open state of the bypass switch 130 in operation S180.

When the voltage regulator 100 determines to switch the bypass switch 130 to the closed state in operation S130, the voltage regulator 100 may switch the bypass switch 130 to the closed state in operation S140.

After the voltage regulator 100 switches the bypass switch 130 to the closed state in operation S140, a determination may be made by the voltage regulator 100 whether to switch the bypass switch 130 to the open state. In other words, when the bypass switch 130 has been in the closed state for a certain time period, it may be considered that the effect of the load transient has diminished or lessened, and the bypass switch 130 may be switched back to the open state. The voltage regulator 100 may compare the difference between the reference voltage VREF and the output voltage VOUT with the reference voltage difference in operation S150.

When the difference between the reference voltage VREF and the output voltage VOUT is less than the reference voltage difference in operation S160, the voltage regulator 100 may determine to switch the bypass switch 130 to the open state.

When the difference between the reference voltage VREF and the output voltage VOUT is greater than the reference voltage difference, the voltage regulator 100 may determine to maintain the closed state of the bypass switch 130.

When the voltage regulator 100 determines to switch the bypass switch 130 to the open state in operation S160, the voltage regulator 100 may switch the bypass switch 130 to the open state in operation S170.

FIG. 8 is a block diagram of an integrated circuit 10a according to some example embodiments. The integrated circuit 10a may be same as or similar in some respects to the integrated circuit 10 of FIGS. 1 and 2, and therefore may be best understood with reference thereto where like numerals indicate like elements not described again in detail.

Referring to FIG. 8, the integrated circuit 10a may include a voltage regulator 100a and the load 200.

The voltage regulator 100a may include an amplifier stage 110a, a pass transistor circuit 120a, the bypass switch 130, the transient detector 140, and/or the feedback capacitor CF.

The amplifier stage 110a may include a first amplifier 111a and the second amplifier 112. The first amplifier 111a in FIG. 8 may correspond to the first amplifier 111 in FIG. 2. The reference voltage VREF may be applied to the non-inverting input terminal of the first amplifier 111a. The inverting input terminal of the first amplifier 111a may be electrically connected to the output node N_OUT. The second amplifier 112 in FIG. 8 may correspond to the second amplifier 112 in FIG. 2.

The pass transistor circuit 120a may include a first pass transistor PT1a, a second pass transistor PT2a, and a frequency compensation circuit 121a. Each of the first pass transistor PT1a and the second pass transistor PT2a may be an NMOS transistor. The frequency compensation circuit 121a may correspond to the frequency compensation circuit 121 in FIG. 1.

The input voltage VIN may be applied to the drain of the first pass transistor PT1a and the drain of the second pass transistor PT2a. The source of each of the first pass transistor PT1a and the second pass transistor PT2a may be electrically connected to the output node N_OUT. The gate of the first pass transistor PT1a may be electrically connected to the first node N1. The gate of the second pass transistor PT2a may be electrically connected to the second node N2.

FIG. 9 is a block diagram of an integrated circuit 10b according to some example embodiments. The integrated circuit 10b may be same as or similar in some respects to the integrated circuit 10 of FIGS. 1 and 2, and therefore may be best understood with reference thereto where like numerals indicate like elements not described again in detail.

Referring to FIG. 9, the integrated circuit 10b may include a voltage regulator 100b and the load 200.

The voltage regulator 100b may include the amplifier stage 110, a pass transistor circuit 120b, the bypass switch 130, the transient detector 140, and/or the feedback capacitor CF.

The pass transistor circuit 120b may include a first pass transistor PT1b, a second pass transistor PT2b, and a frequency compensation circuit 121b. Each of the first pass transistor PT1b and the second pass transistor PT2b may be a PMOS transistor. In some example embodiments, each of the first pass transistor PT1b and the second pass transistor PT2b may be an NMOS transistor, as described above with reference to FIG. 8.

The frequency compensation circuit 121b may correspond to the frequency compensation circuit 121 in FIG. 1. The frequency compensation circuit 121b may include a transistor ARa. The transistor ARa may be an NMOS transistor. The source of the transistor ARa may be electrically connected to the first node N1. The drain of the transistor ARa may be electrically connected to the second node N2. A bias voltage VB may be applied to the gate of the transistor ARa. In some example embodiments, the bias voltage VB may be externally provided to the voltage regulator 100b.

FIG. 10 is a block diagram of an integrated circuit 10c according to some example embodiments. The integrated circuit 10c may be same as or similar in some respects to the integrated circuit 10 of FIGS. 1 and 2, and therefore may be best understood with reference thereto where like numerals indicate like elements not described again in detail.

Referring to FIG. 10, the integrated circuit 10c may include a voltage regulator 100c and the load 200.

The voltage regulator 100c may include the amplifier stage 110, a pass transistor circuit 120c, the bypass switch 130, the transient detector 140, and/or the feedback capacitor CF.

The pass transistor circuit 120c may include a first pass transistor PT1c, a second pass transistor PT2c, and a frequency compensation circuit 121c. Each of the first pass transistor PT1c and the second pass transistor PT2c may be a PMOS transistor. In some example embodiments, each of the first pass transistor PT1c and the second pass transistor PT2c may be an NMOS transistor, as described above with reference to FIG. 8.

The frequency compensation circuit 121c may correspond to the frequency compensation circuit 121 in FIG. 1. The frequency compensation circuit 121c may include a transistor ARb. The transistor ARb may be a PMOS transistor. The drain of the transistor ARb may be electrically connected to the first node N1. The source of the transistor ARb may be electrically connected to the second node N2. The bias voltage VB may be applied to the gate of the transistor ARb. In some example embodiments, the bias voltage VB may be externally provided to the voltage regulator 100c.

FIG. 11 is a block diagram of an integrated circuit 10d according to some example embodiments. The integrated circuit 10d may be same as or similar in some respects to the integrated circuit 10 of FIGS. 1 and 2, and therefore may be best understood with reference thereto where like numerals indicate like elements not described again in detail.

Referring to FIG. 11, the integrated circuit 10d may include a voltage regulator 100d and the load 200.

The voltage regulator 100d may include the amplifier stage 110, a pass transistor circuit 120d, the bypass switch 130, the transient detector 140, and/or the feedback capacitor CF.

The pass transistor circuit 120d may include a first pass transistor PT1d, a second pass transistor PT2d, and a frequency compensation circuit 121d. Each of the first pass transistor PT1d and the second pass transistor PT2d may be a PMOS transistor. In some example embodiments, each of the first pass transistor PT1d and the second pass transistor PT2d may be an NMOS transistor, as described above with reference to FIG. 8.

The frequency compensation circuit 121d may correspond to the frequency compensation circuit 121 in FIG. 1. The frequency compensation circuit 121d may include a capacitor SCR and a switch SSW.

The switch SSW may operate based on a clock signal CLK. The clock signal CLK may be externally provided to the voltage regulator 100d. In some example embodiments, the switch SSW may be switched to the closed state when the logic level of the clock signal CLK is a first logic level. The switch SSW may be switched to the open state when the logic level of the clock signal CLK is a second logic level. The first logic level may correspond to a high level. The second logic level may correspond to a low level. Alternatively, the first logic level may correspond to a low level and the second logic level may correspond to a high level.

A first terminal of the switch SSW may be electrically connected to the first node N1, and a second terminal of the switch SSW may be electrically connected to the second node N2. A first terminal of the capacitor SCR may be electrically connected to the first node N1, and a second terminal of the capacitor SCR may be electrically connected to the second node N2.

FIG. 12 is a block diagram of an integrated circuit 10e according to some example embodiments. The integrated circuit 10e may be same as or similar in some respects to the integrated circuit 10 of FIGS. 1 and 2, and therefore may be best understood with reference thereto where like numerals indicate like elements not described again in detail.

Referring to FIG. 12, the integrated circuit 10e may include a voltage regulator 100e and the load 200.

The voltage regulator 100e may include the amplifier stage 110a, a pass transistor circuit 120e, a first bypass switch 130_1, a second bypass switch 130_2, a transient detector 140e, and/or the feedback capacitor CF.

The pass transistor circuit 120e may include a first pass transistor PT1e, a second pass transistor PT2e, a third pass transistor PT3e, a first frequency compensation circuit 121_1e, and a second frequency compensation circuit 121_2e.

Each of the first pass transistor PT1e, the second pass transistor PT2e, and the third pass transistor PT3e may be a PMOS transistor. However, in some other example embodiments, each of the first pass transistor PT1e, the second pass transistor PT2e, and the third pass transistor PT3e may be an NMOS transistor.

The pass transistor circuit 120e may include three pass transistors and two frequency compensation circuits in some example embodiments. However, in some example embodiments, the pass transistor circuit 120e may include more than 3 pass transistors and/or more than 3 frequency compensation circuits.

The first frequency compensation circuit 121_1e may include a first resistor R1. A first terminal of the first resistor R1 may be electrically connected to the first node N1, and a second terminal of the first resistor R1 may be electrically connected to the second node N2.

The second frequency compensation circuit 121_2e may include a second resistor R2. A first terminal of the second resistor R2 may be electrically connected to the second node N2, and a second terminal of the second resistor R2 may be electrically connected to a third node N3.

The gate of the third pass transistor PT3e may be electrically connected to the third node N3. The input voltage VIN may be applied to the source of the third pass transistor PT3e, and the drain of the third pass transistor PT3e may be electrically connected to the output node N_OUT. A third current I3 may be provided from the drain of the third pass transistor PT3e to the output node N_OUT.

In some example embodiments, the size of the second pass transistor PT2e may be designed to be greater than the size of the first pass transistor PT1e. In some example embodiments, the size of the third pass transistor PT3e may be designed to be greater than the size of the first pass transistor PT1e.

When a transient occurs in the output voltage VOUT of the voltage regulator 100e, the transient detector 140e may detect the transient and control the first bypass switch 130_1 and the second bypass switch 130_2. When the difference between the reference voltage VREF and the output voltage VOUT is greater than the reference voltage difference, the transient detector 140e may control the first bypass switch 130_1 and the second bypass switch 130_2 by generating the control signal CTRL that switches the first bypass switch 130_1 and the second bypass switch 130_2 to the closed state. When the difference between the reference voltage VREF and the output voltage VOUT is less than the reference voltage difference, the transient detector 140e may control the first bypass switch 130_1 and the second bypass switch 130_2 by generating the control signal CTRL that switches the first bypass switch 130_1 and the second bypass switch 130_2 to the open state.

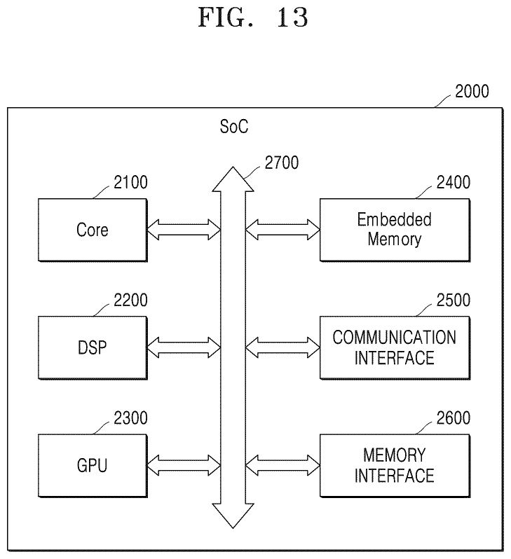

FIG. 13 is a block diagram of a System-on-Chip (SoC) 2000 according to some example embodiments.

Referring to FIG. 13, the SoC 2000 may refer to an integrated circuit in which components of a computing system or another electronic system are integrated. For example, an application processor (AP) as an example of the SoC 2000 may include a processor and components for other functions.

The SoC 2000 may include a core 2100, a digital signal processor (DSP) 2200, a graphics processing unit (GPU) 2300, an embedded memory 2400, a communication interface 2500, and a memory interface 2600. The elements of the SoC 2000 may communicate with one another through a bus 2700.

The core 2100 may process instructions and control the operations of the elements of the SoC 2000. For example, the core 2100 may drive an operating system (OS) by processing a series of instructions and execute applications on the OS. The DSP 2200 may generate data by processing a digital signal, for example, provided from the communication interface 2500. The GPU 2300 may generate data, which corresponds to an image output through a display device, from image data provided from the embedded memory 2400 or the memory interface 2600 or may encode the image data. The embedded memory 2400 may store data necessary for the operations of the core 2100, the DSP 2200, and the GPU 2300. The memory interface 2600 may provide an interface with a memory, e.g., dynamic random-access memory (DRAM) or flash memory, outside the SoC 2000.

The communication interface 2500 may provide serial communication with the outside of the SoC 2000. For example, the communication interface 2500 may access Ethernet and may include a serializer/deserializer (SerDes) for the serial communication.

The communication interface 2500 may be applied to the memory interface 2600. The communication interface 2500 or the memory interface 2600 may receive data signals based on multi-level pulse amplitude modulation (PAMn) and convert the signals into data signals.

The bus 2700 may operate based on one of various bus protocols. The various bus protocols may include at least one selected from the group consisting of an advanced microcontroller bus architecture (AMBA) protocol, a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a mobile industry processor interface (MIPI) protocol, and a universal flash storage (UFS) protocol.

The voltage regulator 100, according to some example embodiments, may convert an input voltage received externally and provide a converted voltage to each of the elements of the SoC 2000.

As described herein, any devices, systems, modules, portions, units, controllers, circuits, and/or portions thereof according to any of the example embodiments, and/or any portions thereof (including, without limitation, the amplifier stage 110, the pass transistor circuit 120, the frequency compensation circuit 121, the bypass switch 130, the transient detector 140, and/or the load 200, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several example embodiments have been provided in the present disclosure, it should be understood that the disclosed systems and methods might be embodied in many other specific forms without departing from the spirit or scope of the present disclosure. The present examples embodiments are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various example embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A voltage regulator comprising:
an error amplifier configured to receive a reference voltage through a first input terminal and electrically connected to an output node of the voltage regulator through a second input terminal;
a first transistor having a gate terminal electrically connected to a first node;
a second transistor having a gate terminal electrically connected to a second node;
a frequency compensation circuit electrically connected to the first node and the second node;
a bypass switch connected in parallel with the frequency compensation circuit; and
a transient detector configured to control the bypass switch based on a change in an output voltage,
wherein the voltage regulator is configured to receive an input voltage through a first terminal of each of the first transistor and the second transistor and output the output voltage through the output node, the output node being electrically connected to a second terminal of each of the first transistor and the second transistor.

2. The voltage regulator of claim 1, wherein a size of the second transistor is greater than a size of the first transistor.

3. The voltage regulator of claim 1, wherein
the first terminal of each of the first transistor and the second transistor is a source, and
the second terminal of each of the first transistor and the second transistor is a drain.

4. The voltage regulator of claim 1, wherein
the first terminal of each of the first transistor and the second transistor is a drain, and
the second terminal of each of the first transistor and the second transistor is a source.

5. The voltage regulator of claim 1, wherein the transient detector includes:
a first comparator configured to output a first comparison signal indicating a result of comparing a first comparison reference voltage with the output voltage;
a second comparator configured to output a second comparison signal indicating a result of comparing a second comparison reference voltage with the output voltage;
an OR gate circuit configured to receive the first comparison signal and the second comparison signal and, based on the first comparison signal and the second comparison signal, generate a control signal; and
an output buffer configured to output the control signal,
wherein a difference between the first comparison reference voltage and the reference voltage corresponds to a reference voltage difference, and a difference between the reference voltage and the second comparison reference voltage corresponds to the reference voltage difference.

6. The voltage regulator of claim 5, wherein the transient detector is further configured to:
generate the control signal to switch the bypass switch to a closed state in response to a difference between the reference voltage and the output voltage being greater than the reference voltage difference; and
generate the control signal to switch the bypass switch to an open state in response to the difference between the reference voltage and the output voltage being less than the reference voltage difference.

7. The voltage regulator of claim 1, wherein
the frequency compensation circuit includes a resistor having a first terminal electrically connected to the first node and a second terminal electrically connected to the second node.

8. The voltage regulator of claim 1, wherein the frequency compensation circuit includes:
a third transistor configured to operate based on a bias voltage, wherein
the bias voltage is applied to a gate of the third transistor,
a source of the third transistor is electrically connected to the first node, and
a drain of the third transistor is electrically connected to the second node.

9. The voltage regulator of claim 1, wherein the frequency compensation circuit includes:
a third transistor configured to operate based on a bias voltage, wherein
the bias voltage is applied to a gate of the third transistor,
a drain of the third transistor is electrically connected to the first node, and
a source of the third transistor is electrically connected to the second node.

10. The voltage regulator of claim 1, wherein the frequency compensation circuit includes:
a capacitor having a first terminal electrically connected to the first node and a second terminal electrically connected to the second node; and
a switch having a first terminal electrically connected to the first node and a second terminal electrically connected to the second node, the switch being configured to operate based on an external clock signal.

11. The voltage regulator of claim 1, wherein an output of the error amplifier is applied to a third node, and wherein the voltage regulator further comprises:
a first amplifier having an input terminal and an output terminal, wherein the input terminal is electrically connected to the third node, and the output terminal is electrically connected to the first node; and
a capacitor having a first terminal electrically connected to the third node, and having a second terminal electrically connected to the second terminal of each of the first transistor and the second transistor.

12. The voltage regulator of claim 1, wherein a load is electrically connected to the output node.

13. An operating method of a voltage regulator, the operating method comprising:
detecting a change in an output voltage of the voltage regulator;
comparing a difference between a reference voltage and the output voltage with a reference voltage difference;
switching a bypass switch to a closed state in response to the difference between the reference voltage and the output voltage being greater than the reference voltage difference;
after switching the bypass switch to the closed state, comparing the difference between the reference voltage and the output voltage with the reference voltage difference; and
switching the bypass switch to an open state in response to the difference between the reference voltage and the output voltage being less than the reference voltage difference.

14. The operating method of claim 13, wherein the voltage regulator includes:
a first transistor having a gate terminal electrically connected to a first node;
a second transistor having a gate terminal electrically connected to a second node;
a frequency compensation circuit electrically connected to the first node and the second node; and
the bypass switch connected in parallel with the frequency compensation circuit.

15. The operating method of claim 14, wherein the comparing the difference between the reference voltage and the output voltage with the reference voltage difference includes:
generating a first comparison signal indicating a result of comparing a first comparison reference voltage with the output voltage;
generating a second comparison signal indicating a result of comparing a second comparison reference voltage with the output voltage; and
generating a control signal for controlling the bypass switch based on an OR operation on the first comparison signal and the second comparison signal,
wherein a difference between the first comparison reference voltage and the reference voltage corresponds to a reference voltage difference, and a difference between the reference voltage and the second comparison reference voltage corresponds to the reference voltage difference.

16. A voltage regulator comprising:
an error amplifier configured to receive a reference voltage through a first input terminal and electrically connected to an output node of the voltage regulator through a second input terminal;
a first transistor having a gate terminal electrically connected to a first node;
a second transistor having a gate terminal electrically connected to a second node;
a third transistor having a gate terminal electrically connected to a third node;
a first frequency compensation circuit electrically connected to the first node and to the second node;
a second frequency compensation circuit electrically connected to the second node and to the third node;
a bypass switch connected in parallel with the first frequency compensation circuit; and
a transient detector configured to control the bypass switch based on a change in an output voltage,
wherein the voltage regulator is configured to receive an input voltage through a first terminal of each of the first transistor and the second transistor and output the output voltage through the output node electrically connected to a second terminal of each of the first transistor and the second transistor.

17. The voltage regulator of claim 16, wherein
a size of the second transistor is greater than a size of the first transistor, and
a size of the third transistor is greater than a size of the first transistor.

18. The voltage regulator of claim 16, wherein the transient detector includes:
a first comparator configured to output a first comparison signal indicating a result of comparing a first comparison reference voltage with the output voltage;
a second comparator configured to output a second comparison signal indicating a result of comparing a second comparison reference voltage with the output voltage;
an OR gate circuit configured to receive the first comparison signal and the second comparison signal and, based on the first comparison signal and the second comparison signal, generate a control signal; and
an output buffer configured to output the control signal,
wherein a difference between the first comparison reference voltage and the reference voltage corresponds to a reference voltage difference, and a difference between the reference voltage and the second comparison reference voltage corresponds to the reference voltage difference.

19. The voltage regulator of claim 18, wherein the transient detector is further configured to:
generate the control signal to switch the bypass switch to a closed state in response to a difference between the reference voltage and the output voltage being greater than the reference voltage difference; and
generate the control signal to switch the bypass switch to an open state in response to the difference between the reference voltage and the output voltage being less than the reference voltage difference.

20. The voltage regulator of claim 16, wherein
at least one of the first frequency compensation circuit and the second frequency compensation circuit includes a resistor having a first terminal electrically connected to the first node and a second terminal electrically connected to the second node.
